(19) United States
(12) Patent Application Publication
(10) Pub. No.: US 2026/0136166 A1
(43) Pub. Date: May 14, 2026

(54) GEOFENCING AROUND EVENT

(71) Applicant: Intrado Life & Safety, Inc., Longmont, CO (US)

(72) Inventors: John Lawrence Snapp, Everett, WA (US); Patrick Arsenault, Montreal (CA); Denis Marin, Kirkland (CA)

(21) Appl. No.: 18/947,229

(22) Filed: Nov. 14, 2024

(51) Int. Cl. H04W 4/90; H04M 3/51; H04W 4/021

(52) U.S. Cl. CPC H04W 4/90; H04M 3/5116; H04W 4/022

(57) ABSTRACT

Particular example embodiments described herein can provide for a system, an apparatus, and a method for creating a geofence around an event, creating a phase one gate around the geofence, receiving a communication at a public safety answering point (PSAP), and conditioned upon general location data included in the communication received at the PSAP indicating the communication originated inside the phase one gate, delaying the communication until precise location data for the communication determines if the communication originated inside the geofence or outside of the geofence.

### TECHNICAL FIELD

This disclosure relates in general to the field of computing and/or networking and, more particularly, to a system, an apparatus, and a method to enable geofencing around an event.

### BACKGROUND

A public-safety answering point (PSAP), sometimes called a public-safety access point, is a call center where emergency/non-emergency calls (like police, fire brigade, ambulance) are received and handled. The PSAP is a call center in almost all the countries, including Canada and the United States, where a trained PSAP operator is typically responsible for answering calls to an emergency telephone number for police, firefighting, and ambulance services. Some PSAPs have the ability to receive and respond to text messages.

In Canada and the United States, counties are generally bound to provide a PSAP and other emergency services even within municipalities, unless the municipality chooses to opt out and have its own system. Each PSAP has a ‘real’ telephone number that is called when an emergency number (e.g., 911) is dialed or texted. The telecommunications operator is responsible for associating all landline numbers with the most applicable (often the nearest) PSAP, such that when the emergency number is dialed, the call or text is automatically routed to the most suitable PSAP.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a system to help enable geofencing around an event, in accordance with an embodiment of the present disclosure;

FIG. 1B is a simplified block diagram of a system to enable geofencing around an event, in accordance with an embodiment of the present disclosure;

FIG. 1C is a simplified block diagram of a system to enable geofencing around an event, in accordance with an embodiment of the present disclosure;

FIG. 2 is a simplified block diagram of a particular implementation of a communication engine to help enable geofencing around an event, in accordance with an embodiment of the present disclosure;

FIGS. 3A and 3B are simplified block diagrams illustrating example details of a particular implementation to help enable geofencing around an event, in accordance with an embodiment of the present disclosure;

FIG. 4 is a simplified block diagram illustrating example details of a system to help enable geofencing around an event, in accordance with an embodiment of the present disclosure;

FIG. 5 is a simplified block diagram illustrating example details of a particular implementation to help enable geofencing around an event, in accordance with an embodiment of the present disclosure;

FIG. 6A-6C are a simplified block diagram illustrating example details of a particular implementation to help enable geofencing around an event, in accordance with an embodiment of the present disclosure;

FIG. 7 is simplified block diagram illustrating example details of a particular implementation to help enable geofencing around an event, in accordance with an embodiment of the present disclosure;

FIG. 8 is a simplified flowchart illustrating potential operations to help enable geofencing around an event, in accordance with an embodiment of the present disclosure;

FIG. 9 is a simplified flowchart illustrating potential operations to help enable geofencing around an event, in accordance with an embodiment of the present disclosure;

FIG. 10 is a simplified flowchart illustrating potential operations to help enable geofencing around an event, in accordance with an embodiment of the present disclosure;

FIG. 11 is a simplified flowchart illustrating potential operations to help enable geofencing around an event, in accordance with an embodiment of the present disclosure;

FIG. 12 is a simplified flowchart illustrating potential operations to help enable geofencing around an event, in accordance with an embodiment of the present disclosure;

FIG. 13 is a simplified block diagram illustrating example details of an example computer model inference and computer model training to help enable geofencing around an event, in accordance with an embodiment of the present disclosure; and

FIG. 14 is a simplified block diagram illustrating examples details of an example neural network architecture to enable geofencing around an event, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to enabling a geofence around an event, in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

A public safety answering point (PSAP) sometimes called a public-safety access point, is a call center where emergency/non-emergency calls (like police, fire brigade, ambulance) are received and handled. When an event occurs, especially if the event is an emergency event (e.g. car accident, fire, natural disaster, shooting, etc.), often there will be multiple communications to the PSAP related to the emergency event. Other than the first few communications to the PSAP where the PSAP is first alerted about the emergency event, most of the multiple communications will not have any new information about the emergency event for the PSAP operator. However, each communication to the PSAP needs to be reviewed to ensure it is not about a new emergency event or does not include new valuable information about the emergency event and reviewing each of the multiple communications to the PSAP can take up valuable resources at the PSAP and may prevent other communications to the PSAP from being timely received or properly addressed.

In an illustrative example, a geofence can be created around the emergency event and communications that originated inside the geofence can be routed according to rules associated with the geofence. This allows PSAP operators to focus on communications that most need the PSAP operator's attention. For example, if most of the communications related to an emergency event do not need immediate attention from a PSAP operator, the communications that originated from inside a geofence around the emergency event can be routed to an interactive voice response system (IVR), automatic answering system with a general message about the emergency event, or otherwise given a lower priority and allow the PSAP operator to timely address and respond to communications outside the geofence that may have a higher priority as compared to communications from inside the geofence. If the communication is routed to an automatic answering system, an option can be provided to the user that originated the communication for the communication to be routed to a PSAP operator, for example, to report a new emergency event or provide vital information about the emergency event. In another example, if most of the communications related to an emergency event do need immediate attention from a PSAP operator (e.g., in the case of an active shooter where as much information about the event is needed), the communications that originated from inside the geofence around the emergency event can be given top priority over communications outside of the geofence.

In an illustrative example, an emergency event can occur. The emergency event can be an event where emergency services are or will be routed to the emergency event or an event where multiple users believe the event necessitates communicating with emergency services. More specifically, the emergency event may be a car accident, fire, hostage event, shooting, earthquake, or some other event where emergency services are or will be routed to the emergency event.

When communications are received about the emergency event, a communication analysis engine can determine that a geofence should be established in the area around the emergency event. In another example, a human operator at the PSAP can determine that a geofence should be established in the area around the emergency event. In yet other examples, the communication analysis engine can suggest that a geofence should be established in the area around the emergency event and a human operator at the PSAP can activate or implement the geofence around the emergency event. In some examples, the human operator at the PSAP can alter or change the area the geofence covers. In some examples, rules can be applied to the geofence. For example, a rule can be applied that all communications inside the geofence are routed to an automated message about the emergency event (e.g., “We are aware of the emergency event and have dispatched help.”). In another example, where as much information about the emergency event is needed (e.g., an active shooter) a rule can be applied that all communications inside the geofence are routed to PSAP operators. In yet another example, a rule can be applied that all communications are routed to a specific PSAP operator who is handling the response to the emergency event. By creating a geofence around the emergency event, communications that originate from inside the geofence can be routed (using the rules) in such a way that allows PSAP operators to focus on the communications that most need the PSAP operator's attention.

In some examples, a first phase gate is created around the geofence to help provide an early indication about whether or not a communication originated from inside the geofence. The first phase gate is used to reduce the wait on calls that are outside the geofence and to help minimize call processing. The first phase gate is set up based on a common location feature of the calls that were used to set up the geofence. For example, cell tower information is included in all cellular calls and texts when the cellular calls and text first arrive at a PSAP and the cell tower information can be used to help determine if a communication may be in the geofence. Communications that are outside of the phase one gate are communicated to the typical PSAP processing queue and communications that are inside the phase one gate are slightly delayed (e.g., less than about 15 seconds, less than about 30 seconds, less than about 45 seconds, less than about 60 seconds, etc.) to determine precise location information for the communication and determine if the communication originated from inside the geofence.

### Example Systems, Apparatuses, and Methods

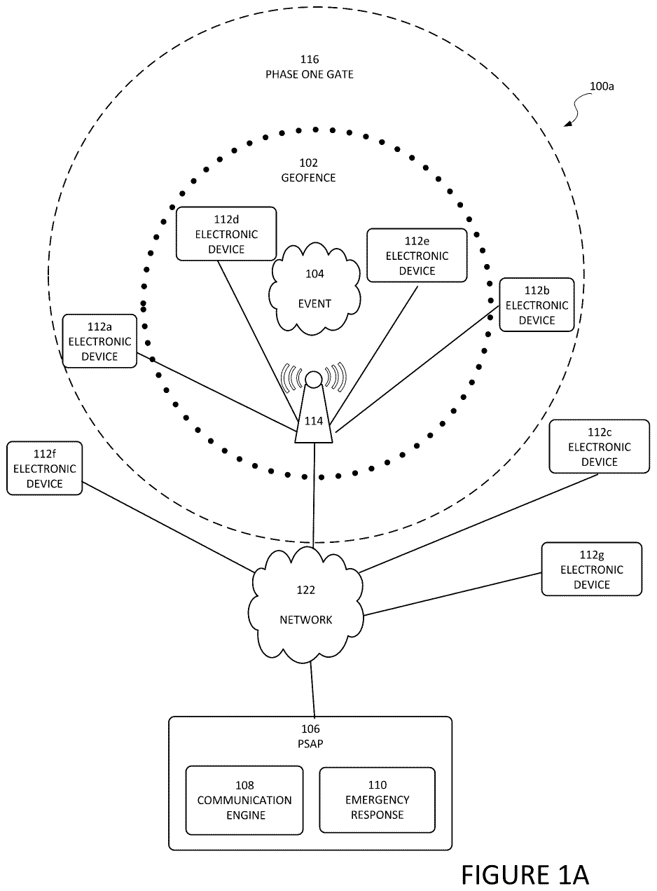

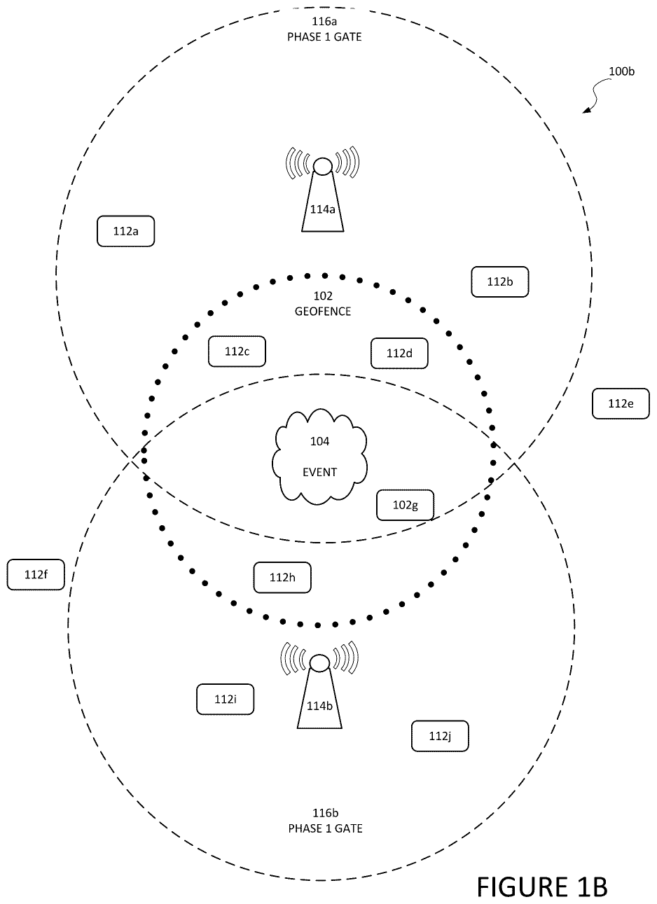

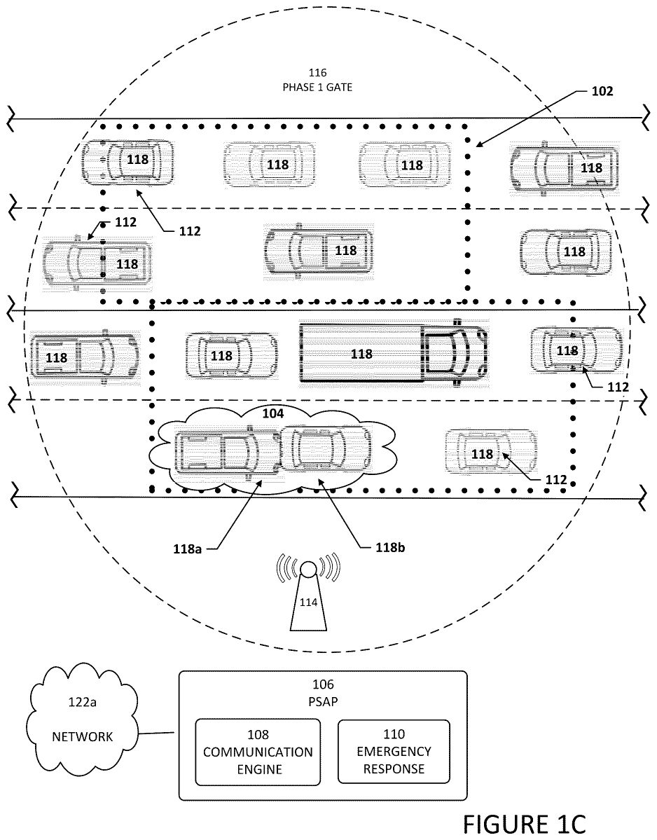

FIG. 1A is simplified block diagram of a particular non-limiting system 100a to enable a geofence 102 around an emergency event 104. The system 100a can include a PSAP 106. The PSAP 106 can include a communication engine 108 and an emergency response center 110. The emergency response center 110 is where communications to the PSAP 106 are handled by one or more PSAP operators and emergency services are dispatched, if needed. The PSAP 106 and electronic devices 112 can be in communication with each other using a network 122.

In an illustrative example, an emergency event 104 can occur. The emergency event 104 can be an event where emergency services are routed to the emergency event 104 or an event where multiple users believe the event necessitates communicating with emergency services. For example, the emergency event may be a fire, a car accident, hostage event, shooting, earthquake, wild animal citing, load noise complaint, noxious smell complaint, etc. While initial communications are needed to obtain more details about the emergency event 104 and determine the type of response if any, often several communications about the emergency event 104 will be sent to the PSAP 106 that do not have any additional information about the emergency event 104. These communications that do not have additional information about the emergency event 104 can consume valuable PSAP resources. By creating the geofence 102 around the emergency event 104, communications that originate within the geofence 102 can be presumed to be about the emergency event 104 and the communications can be routed to an appropriate destination. For example, if the PSAP operator has enough details related to the emergency event and/or emergency responders have already been dispatched to the emergency event 104, communications that originate inside the geofence 102 can be routed to an automated response line, an IVR, a PSAP operator that is handling the emergency event 104, etc. More specifically, if the emergency event 104 is a vehicle accident, the automated response line can provide an automatic response that says for example, “Thank you for calling. If you are calling about the vehicle accident on I-35 near the I-820 exit, help has been dispatched. If you are not calling about the vehicle accident on I-35 near the I-820 exit or have information you would like to share about the vehicle accident on I-35 near the I-820 exit, please press pound one on your device.” The prompt pound one is a prompt that can be offered for the user to be connected to an emergency PSAP operator in case the communication is not about the emergency event 104 or includes additional information related to the emergency event 104 (e.g., in the case of a hit and run, a user may know the license plate of the vehicle that left the scene). The prompt can be a request to push buttons “#” and “1” on a device, a voice prompt, or some other type of action that can allow the user that sent the communication to be routed to a PSAP operator. In some examples, if the prompt is used, the PSAP operator will be given a notice that the user that originated the communication is communicating about an event other than the emergency event 104 or has additional information about the emergency event 104.

In some examples, two prompts may be offered, where one prompt is if the communication is not about the emergency event 104 and the second prompt is if the communication includes additional details related to the emergency event 104. For example, the user that originated the communication can press pound (“#”) one (1) if the communication is not related to the emergency event 104 to be connected to a PSAP operator and can press pound (“#”) two (2) if the user has additional information related to the emergency event 104 and be connected to a PSAP operator that is handling the event or be connected to a voice mailbox to leave a recorded message about the additional information related to the emergency event 104. In some examples, activating the prompt that indicates the user has additional information related to the emergency event 104 will connect the user to an IVR to obtain more information about the nature of the communication.

In an example, when communications are received at the PSAP 106, the communication engine 108 can analyze the communications and determine if the communications are related to an event that does not have a geofence around the event. Based on the type of the event (vehicle accident, fire, an event that will or might require emergency services, etc.), the number of communications received about the event, and/or other factors, the communication engine 108 can determine that the event is an emergency event 104 and a geofence 102 should be established in the area around the emergency event 104. In some examples, a trained computer model or AI system can analyze one or more communications related to the emergency event and create the geofence 102 in the area around the emergency event 104.

In another example, a human operator at the PSAP 106 can determine that a geofence 102 should be established in the area around the emergency event 104. In yet other examples, the communication engine 108 can suggest that a geofence 102 should be established in the area around the emergency event 104 and a human operator at the PSAP 106 can activate the geofence 102. In some examples, the human operator at the PSAP 106 can alter or change the area the geofence 102 covers. In some examples, rules can be applied to the geofence 102. For example, a rule can be applied that all communications inside the geofence 102 are routed to an automated message about the emergency event 104. In another example, a rule can be applied that all communications inside the geofence are routed to PSAP operators or even a specific PSAP operator.

After the geofence 102 is created, a phase one gate 116 is created to help provide an early indication about whether or not a communication originated from inside the geofence 102 and to reduce the wait time on calls that are outside the geofence 102 and help minimize call processing. The phase one gate 116 is set up based on a common location feature of the communications that were used to set up the geofence 102. For example, information about the cell tower 114 used to help facilitate the communication to the PSAP 106 would be included in the cellular calls and texts about the emergency event 104 when the cellular calls and text first arrive at the PSAP 106. The cell tower information can be used to create the phase one gate 116 and to help determine if a communication may be in the geofence 102 without delaying the response time of the PSAP operator. Communications that are outside of the phase one gate 116 are communicated to the typical PSAP processing queue without a delay and communications that are inside the phase one gate 116 are slightly delayed (e.g., less than about 15 seconds, less than about 30 seconds, less than about 45 seconds, less than about 60 seconds, etc.) to determine precise location information and determine if the communication originated from inside the geofence 102.

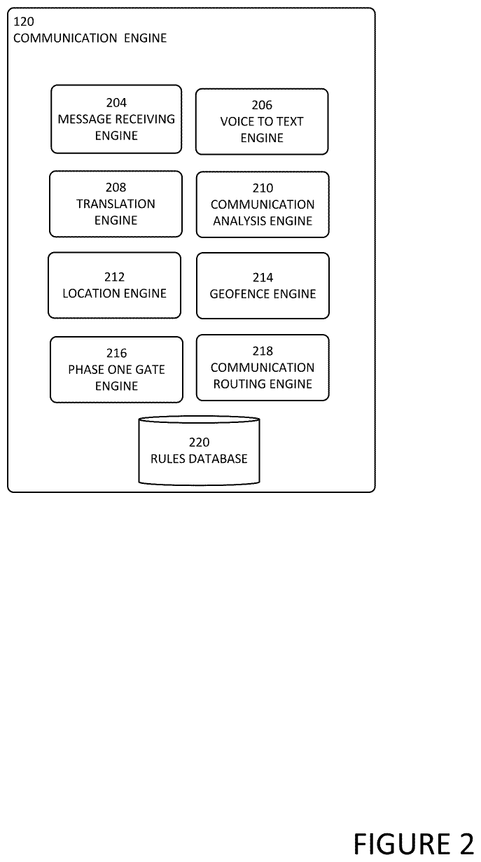

Turning to FIG. 1B, FIG. 1B illustrates a particular non-limiting system 100b to enable a geofence 102 around an emergency event 104. In an illustrative example, an emergency event 104 occurred and, based on communications to a PSAP (not shown), the geofence 102 was created. In addition, based on common location feature of the communications that were used to set up the geofence, one or more phase one gates were created to reduce the wait on calls that are outside the geofence and to help minimize call processing. More specifically, as illustrated in FIG. 2B, two phase one gates were created, phase one gate 116a and phase one gate 116b. The phase one gate 116a was created using information from cell tower 114a and the phase one gate 116b was created using information from cell tower 114b.

In an illustrative example, when communications from electronic devices 112a-112d, are received by the PSAP, the cell tower data indicates that the communications used the cell tower 114a to help facilitate the communication and the communications are delayed (e.g., less than about 15 seconds, less than about 30 seconds, less than about 45 seconds, less than about 60 seconds, etc.) to determine more precise location data for the communications and determine if the communications from the electronic devices 112a-112d originated from inside the geofence 102. Similarly, when communications from electronic devices 112g-112j, are received by the PSAP, the cell tower data indicates that the communications used the cell tower 114b to help facilitate the communication and the communications are delayed (e.g., less than about 15 seconds, less than about 30 seconds, less than about 45 seconds, less than about 60 seconds, etc.) to determine more precise location data for the communications and determine if the communications from the electronic devices 112g-112j originated from inside the geofence 102. Communications from electronic devices 112e and 112f are not delayed because the communications from the electronic devices 112e and 112f did not go through either cell tower 114a or 114b.

Turning to FIG. 1C, FIG. 1C illustrates a specific example where the emergency event 104 is a vehicle accident. More specifically, vehicle 118a has rear-ended vehicle 118b. As users in vehicles 118 with electronic devices 112 drive past the emergency event 104, often multiple users will send a communication to the PSAP 106 to report the emergency event 104. Because the volume of communications can tie up PSAP resources, a geofence 102 around the area of the emergency event 104 can be created. In addition, because precise location data is not immediately available when a communication arrives at the PSAP 106, the phase one gate 116 can be created to help provide an early indication about whether or not a communication originated from inside the geofence 102 and to reduce the wait time on calls that are outside the geofence and help minimize call processing. The phase one gate 116 can be set up based on a common location feature of the calls and texts that were used to set up the geofence 102. For example, cell tower information included in calls that used cell tower 114 to help facilitate the communication are included in the cellular calls and texts when the cellular calls and text first arrive at the PSAP 106 and the cell tower information can be used to help determine if a communication may be in the geofence 102.

Note that the geofence 102 may not have a circular profile or the same profile as the geofence 102 illustrated in FIG. 1A because the emergency event 104 is on a road way. More specifically, the geofence 102 can have a rectangular profile that extends along the side of the road where the emergency event 104 is location and another offset rectangular profile that extends along the side of the road that is opposite of where the emergency event 104 is location. The reason for the offset in the boundaries of the geofence 102 is due to the fact that users will often communicate about the emergency event 104 after they have passed the emergency event 104.

It is to be understood that other embodiments and implementations may be utilized, and structural changes may be made without departing from the scope of the present disclosure. Substantial flexibility is provided by the system and method in that any suitable arrangements and configuration may be provided without departing from the teachings of the present disclosure. For purposes of illustrating certain example techniques to enable gathering information related to geofencing around an event, the following foundational information may be viewed as a basis from which the present disclosure may be properly explained. A number of prominent technological trends are currently afoot (e.g., more mobile computing devices, more mobile services, more Internet traffic), and these trends are changing the media delivery landscape. One trend is the ability to communicate using a portable wireless device such as a cell phone or smart phone. These portable wireless devices allow user to easily communicate with others, especially with a PSAP regarding an emergency event.

A PSAP, sometimes called a public-safety access point, is a call center where emergency/non-emergency calls (like police, fire brigade, ambulance) are received. When a communication is sent to a PSAP, a highly trained professional human PSAP operator is expected to respond to the communication. However, PSAP operators are part of an industry under immense pressure because of understaffing and a host of other issues. PSAP centers are struggling with surging call and text volumes, complex compounded emergencies, outdated technologies, and insufficient support. Because operators at the PSAPs need to handle each call and text, calls and text to the PSAP that are related to the same emergency event and do not provide any additional details about the emergency event waste precious time of the PSAP operators and prevent the PSAP operators from handling other emergencies. This adds to the stress the PSAP operators face every day and is another deterrent to employee retention. What is needed is a system, an apparatus, and a method to help route communications related to a known emergency event in a way that that allows the PSAP operator(s) to focus their attention on the communications that need the PSAP operator's attention.

A system, method, apparatus, means, etc. to help enable geofencing around an event can help resolve these issues (and others). In an example, a system and method can include a communication analysis engine (e.g., the communication analysis engine 210) to help enable the system to create a geofence around an emergency event. In an illustrative example, an emergency event can occur and a geofence can be created in the area of the emergency event. The geofence can be created by the communication analysis engine, by a PSAP operator, or suggested by the communication analysis engine and implemented by the PSAP operator. In addition, one or more rules can be associated with the geofence. In some examples, a computer model or machine learning can create the geofence or suggest a geofence for a PSAP operator to implement or activate.

When communications from electronic devices inside the geofence are received, the rules can be used to determine how to route the communications. For example, a geofence can be created with a rule that all communications inside the geofence are to be routed to an automated answering system (e.g., as system with a recorded message that says “thank you for communicating about the emergency event, we are aware of it and help is on the way.”). In another example, a geofence can be created with a rule that all communications inside the geofence are to be given a high priority (e.g., in the case of an active shooter where as much information about the event is needed). In yet another example, a geofence can be created with a rule that all communications inside the geofence are to be routed to a specific PSAP operator that is familiar with the event and can help provide needed information related to the event.

In some examples, the precise location of the electronic device that originated the communication in not known when the communication first reaches the PSAP and it can be difficult to determine if the communication originated from inside the geofence. In those examples, a first phase gate is created to help provide an early indication about whether or not a communication originated from inside the geofence. The first phase gate is used to reduce the wait time on communications that are outside the geofence and to help minimize communication processing. The first phase gate is set up based on analyzing the communications that were used to set up the geofence to identify a common location feature included in communications when the communications first arrive at the PSAP. For example, cell tower information is included in the cellular calls and texts when the cellular calls and text first arrive at a PSAP and the cell tower information can be used to help determine if a communication may have originated from inside the geofence. For examples, a specific cell tower's coverage can include at least a portion of the area covered by the geofence so calls and text that are routed through the specific cell tower are likely to be withing the geofence. If a cell tower does not provide any coverage that extends into the area covered by the geofence, then calls and texts that go through the cell tower are not going to be within the geofence. Communications that are outside of the phase one gate are communicated to the typical PSAP processing queue and communications that are inside the phase one gate are slightly delayed (e.g., less than about 15 seconds, less than about 30 seconds, less than about 45 seconds, less than about 60 seconds, etc.) to determine more precise location information and determine if the communication originated from inside the geofence.

Turning to FIG. 2, FIG. 2 is a simplified block diagram illustrating example details of a particular non-limiting implementation of the communication engine 108 of FIGS. 1A and 1C. The communication engine 108 can include a message receiving engine 204, a voice to text engine 206, a translation engine 208, a communication analysis engine 210, a location engine 212, a geofence engine 214, a phase one gate engine 216, a communication routing engine 218, and a rules database 220.

The message receiving engine 204 receives text communications (e.g., text messages), audio communications (e.g., voice messages or phone calls) and/or video communications (e.g., video messages or video calls). The voice to text engine 206 converts audio communication and voice messages into text. The translation engine 208 translates received communications into a preferred language of the PSAP operator. For example, if the preferred language of the human PSAP operator is English, then the translation engine will convert received communications into English. The translation engine 208 can also translate communication with the user of the electronic device 112 that originated the communication into a preferred language of the user of the electronic device 112.

The communication analysis engine 210 can be configured to analyze the communication and determine details and/or data related to the communication. For example, details about the nature of the communication and if the communication is related to the emergency event can be determined. The details about the nature of the communication can be used to help determine if a geofence should be established and the size and shape of the geofence. Also, determining what communications are related to the emergency event can be used to help determine if a geofence should be established based on the number of communications related to the emergency event and, if a geofence should be established, the size and shape of the geofence.

The location engine 212 can be configured to determine both general location information and precise location information for communications. The general location information can be used to create the phase one gate as well as determine when communications originate from inside the phase one gate. The precise location can be used to create the geofence as well as determine when communications originate from inside the geofence.

In some examples, if the communication was received over a wireless network, the communication may include general location information in the form of data related to the cell tower used to facilitate the communication. Also, the precise location information can include the originating location of the communication, the longitude and latitude of the originating location of the communication, height above sea level of the originating location of the communication, height above ground conversion of the originating location of the communication, speed and direction as it relates to the originating location of the communication, and other data. In some examples, the communication engine 108 can infer speed and direction based on the timing between two locations (e.g., determine a location and then five seconds another location to deduce the speed).

The geofence engine 214 can be configured to create and implement a geofence around an emergency event. For example, based on the type of emergency event, the geofence engine 214 can automatically (e.g., without direct human intervention) determine that a geofence should be created or established and automatically create and implement a geofence around the emergency event 104. In another example, in contrast to automatically determining that a geofence should be created or established, a human operator at the PSAP can determine that a geofence should be created or established in the area around the emergency event 104, the human operator at the PSAP can create the geofence, and the geofence engine 214 can implement the geofence. In yet other examples, the geofence engine 214 can suggest that a geofence should be created or established in the area around the emergency event 104 and a human operator at the PSAP can activate the geofence. In some examples, the human operator at the PSAP can alter or change the area the geofence covers.

The phase one gate engine 216 can be configured to create an implement a phase one gate around a geofence. For example, the phase one gate engine 216 can automatically (e.g., without direct human intervention) create or establish and implement a phase one gate around the geofence. In another example, in contrast to automatically determining the phase one gate, a human operator at the PSAP can create the phase one gate and the phase one gate engine 216 can implement the phase one gate. In yet other examples, the phase one gate engine 216 can suggest that a phase one gate should be created or established in the area around the emergency event 104 and a human operator at the PSAP can activate the phase one gate. In some examples, the human operator at the PSAP can alter or change the area the phase one gate covers.

The communication routing engine 218 routes each communication to the PSAP according to whether or not the communication originated from inside the phase one gate and/or the geofence. For example, the location engine 212 is configured to determine location data that can indicate if the communication originated inside a phase one gate. If the communication did not originate inside a phase one gate, the communication is routed to a standard processing queue at the PSAP without delaying the communication to determine precise location data. If the communication did originate inside the phase one gate, the commutation is delayed to determine precise location data and to determine if the communication originated from inside the geofence. If the communication did not originate inside the geofence, the communication is routed to a standard processing queue at the PSAP. If the communication did originate inside the geofence, the communication is routed according to one or more rules from the rules database 220.

The rules database 220 can include rules that can be associated with a geofence. More specifically, in an example, the rules can include a rule that routs all communications that originated inside the geofence to an automated answering system or IVR. In another example, the rules can include a rule that routs all communications that originated inside the geofence to one or more PSAP operators that are knowledgeable about the emergency event in the geofence. In yet another example, the rules can include a rule that prioritizes all communications that originated inside the geofence with a highest priority level. In some examples, the rules can include a rule that routs all communications that originated inside the geofence to a message recording line where the user that originated the communication can leave a message regarding the emergency event. Note that the above described rules are only examples and not intended to be limiting. The above described rules can be altered or new rules can be created and stored in the rules database 220.

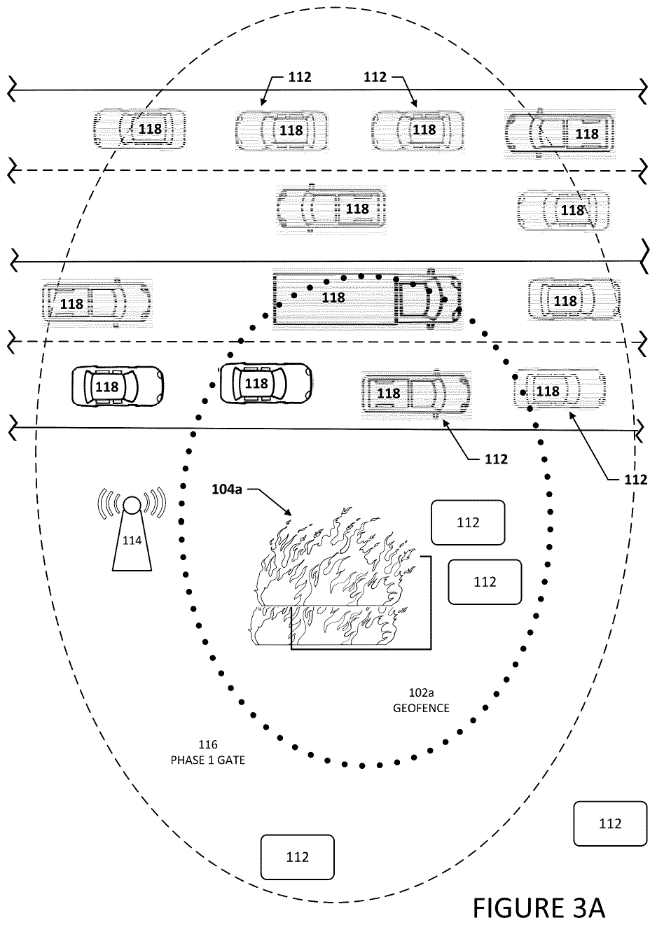

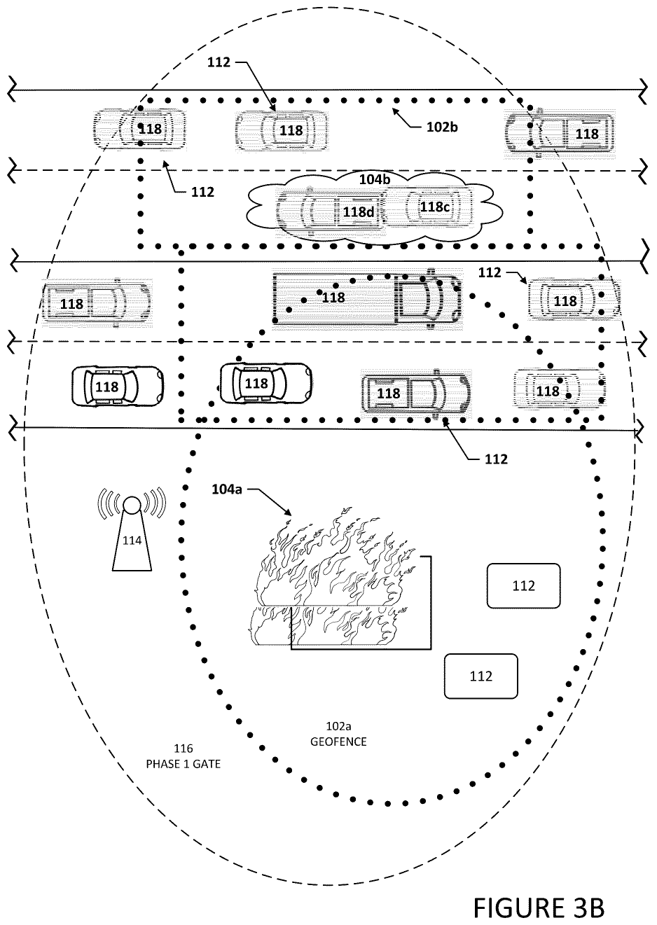

Turning to FIG. 3A, FIG. 3A illustrates a specific example where the emergency event 104a is a fire. As users with electronic devices 112 see the fire and users in vehicles 118 with electronic devices 112 drive past the emergency event 104a, often multiple users will send a communication to the PSAP to report the emergency event 104a and the communications will go through the cell tower 114. Because the volume of communications can tie up PSAP resources, a geofence 102a around the area of the emergency event 104a can be created with a phase one gate 116 that includes the cell tower 114. While FIG. 3A illustrates the geofence having a circular profile, in some examples, because the emergency event 104 is near a road way, the geofence 102a may not have a circular profile or a portion of the geofence may have a circular profile and a portion of the geofence along the roadway can have an offset rectangular profile that follows the roadway, similar to the geofence illustrated in FIG. 1B.

By creating the phase one gate 116 around the geofence 102a, communications that are not in the phase one gate 116 are not delayed to determine precise location data for the communication as communications outside the phase one gate 116 will not be within the geofence 102a. By creating the geofence 102a around the emergency event 104a, communications within the geofence 102a can be presumed to be about the emergency event 104a and the communications can be routed based on one or more rules associated with the emergency event 104a. For example, if the PSAP operator has enough details related to the emergency event 104a and/or emergency responders have already been dispatched to the emergency event 104a, communications that originate inside the geofence can be routed to an automated response line, an IVR, a PSAP operator that is handling the emergency event 104a, etc. More specifically, if the emergency event 140a is a fire and the communication is a phone call, the automated response line can provide an automatic response that says for example, “Thank you for calling. If you are calling about the building on fire in Longmont, help has been dispatched. If you are not calling about the fire in Longmont or have information you would like to share about the fire in Longmont, please press pound one on your device.” The prompt pound one is a prompt that can be offered for the user to be connected to an emergency operator at the PSAP in case the communication is not about the emergency event 104a or if the user has additional information related to the emergency event 104a (e.g., in the case of a possible arson suspect, a user may have details about a suspected arson). The prompt can be a request to push buttons “#” and “1” on a device, a voice prompt, or some other type of action that can allow the user that sent the communication to be routed to a PSAP operator. In some examples, if the prompt is used, the PSAP operator will be given a notice that the user that originated the communication is communicating about an event other than the emergency event 104a or has additional information about the emergency event 104a.

In some examples, three or more prompts may be offered. For example, in the example of three prompts, one prompt may be if the communication is not about the emergency event 104a, a second prompt may if the communication includes additional details related to the emergency event, and a third prompt may be if the communication is about a new emergency event. For example, the user that originated the communication can press pound one if the communication is not related to the emergency event, can press pound two if the user has additional information related to the emergency event, and can press pound three if the user wants to report a different emergency event, for example, a vehicle accident that has occurred near the emergency event 104a, as illustrated in FIG. 3B.

Turning to FIG. 3B, FIG. 3B illustrates a specific example where the emergency event 104a is a fire and the emergency event 104b is a vehicle accident. As illustrated in FIG. 3A, the geofence 102a was created around the fire emergency event 104a. As illustrated in FIG. 3B, a second emergency event 104b, a vehicle accident, occurred inside the phase one gate 116. More specifically, vehicle 118c has rear-ended vehicle 118d. As users in vehicles 118 with electronic devices 112 drive past the emergency event 104b, often multiple users will send a communication to the PSAP to report the emergency event 104b.

Because the emergency event 104b is inside the phase one gate 116 that was established when the geofence 102a was established, at least a portion of the communications regarding the emergency event 104b will be slightly delayed (e.g., less than about 15 seconds, less than about 30 seconds, less than about 45 seconds, less than about 60 seconds, etc.) while precise location data is obtained for the communications inside the phase one gate 116. Using the precise location data, the system can determine that at least some of the communications regarding the emergency event 104b are outside of the geofence 102a and do not relate to the emergence event 104a and a new geofence (geofence 102b) needs to be established around the emergency event 104b. In some examples, the precise location data for communications related to emergency event 104b may indicate the communication originated inside the geofence 102a and will be routed according to the one or more rules associated with the geofence 102a. If the communication is routed to an automated answering system, the automated answering system can include a prompt that will allow the user to report a new emergency event. For example, in the example described above, the user can select the third prompt to report a different emergency event.

When one or more communications related to the emergency event 104b are received, the new geofence 102b can be created and in some examples, at least a portion of the geofence 102b associated with the emergency event 104b can overlap with the geofence 102a associated with the emergency event 104a. Communications that originate inside both the geofence 102a and 102b can be routed to an automated response line that provides an automatic response that says for example, “Thank you for calling. If you are calling about the building on fire in Longmont or the vehicle accident near the fire in Longmont, help has been dispatched. If you are not calling about the fire in Longmont or the vehicle accident near the fire in Longmont or have information you would like to share about either emergency event, please press pound one on your device.” The prompt pound one is a prompt that can be offered for the user to be connected to a PSAP operator in case the communication is not about the emergency event 104a or the emergency event 104b or includes additional information related to the emergency event 104a (e.g., in the case of a possible arson suspect, a user may have a description of the suspected arson) or includes additional information related to the emergency event 104b (e.g., in the case of a hit and run where the user may know the license plate of the vehicle that left the scene). The prompt can be a request to push buttons “#” and “1” on a device, a voice prompt, or some other type of action that can allow the user that sent the communication to be routed to a PSAP operator. In some examples, if the prompt is used, the PSAP operator will be given a notice that the user that originated the communication is communicating about an event other than the emergency event 104a or the emergency event 104b or has additional information about the emergency event 104a or the emergency event 104b.

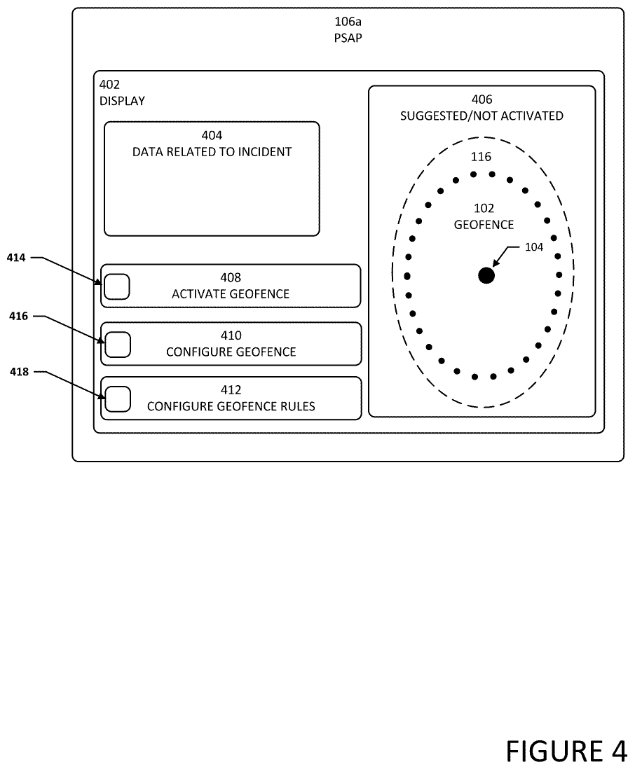

Turning to FIG. 4, FIG. 4 is simplified block diagram illustrating non-limiting examples details of a display 402 at the PSAP 106. The display 402 can be a display that is viewed by a human operator at the PSAP 106. Note that that display 402 can display other information to the human operator at the PSAP 106, the information on the display 402 may be presented in a different way, and/or the information on the display 402 may be in a different layout. FIG. 4 illustrates one non-limiting example of the information and layout of the display 402 to help enable geofencing around an event.

As illustrated in FIG. 4, the display 402 can include a data related to the incident portion 404, an incident representation 406, an activate geofence portion 408, a configure geofence portion 410, and a configure geofence rules portion 412. The data related to the incident portion 404 can include data related to the emergency event 104. More specifically, the data related to the incident portion 404 can include a location of the emergency event 104, the type of emergency event 104 (e.g., a fire, car accident, robbery, etc.), type and/or location of emergency services needed to respond to the emergency event 104 and other details a human PSAP operator may need to help enable the human PSAP operator, another human PSAP operator, or other response personal respond to the emergency event 104. As illustrated in FIG. 4, the geofence 102 has been suggested by the geofence engine 214 (illustrated in FIG. 2) and the phase one gate 116 has been suggested by the phase one gate engine 216 (illustrated in FIG. 2), but not yet activated.

The incident representation 406 can include visual representation of the geofence 102 (if there is a geofence), a visual representation of the phase one gate 116 (if there is a first phase gate), and a visual representation of the emergency event 104. In some examples, the incident representation 406 can also include a visual representation of the area (e.g., streets, building, landscape, etc. around the emergency event 104. The activate geofence portion 408 can include an activate geofence indicator 414 that allows the human PSAP operator to activate and deactivate the geofence 102 and the phase one gate 116. Note that if the geofence 102 is not activated, the phase one gate 116 will not be activated as there would not be a reason to delay communications to determine precise location data if the precise location data is not needed. The configure geofence portion 410 can include configure geofence selector 416 that allows the human PSAP operator to configure or change the shape, location, area covered, etc. of the geofence 102. In some examples, when the geofence 102 is reconfigured, the phase one gate 116 is automatically reconfigured to ensure the phase one gate 116 covers the area of the geofence 102. The configure geofence rules portion 412 can include a configure geofence rules selector 418 that allows the human PSAP operator to configure and associate one or more rules for the geofence 102.

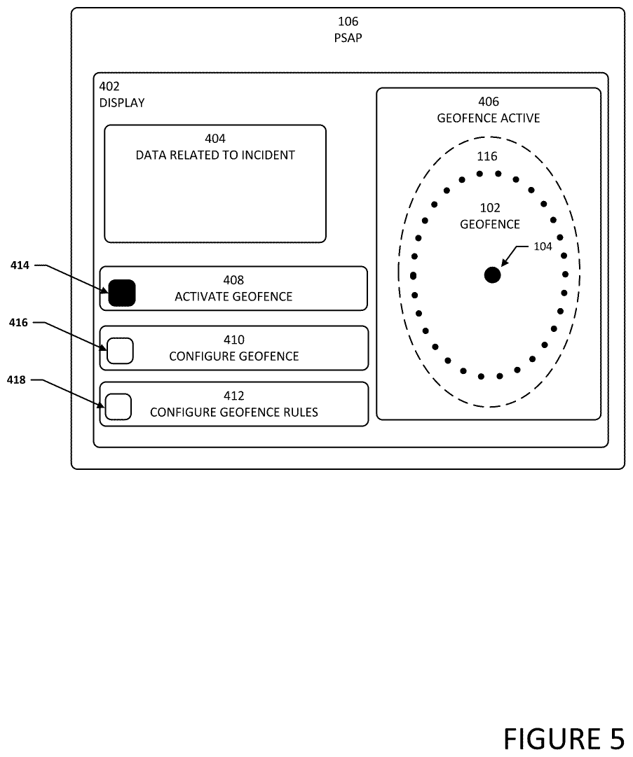

Turning to FIG. 5, FIG. 5 is a simplified block diagram illustrating specific non-limiting example details of the display 402 at the PSAP 106. As illustrated in FIG. 5, the geofence 102 illustrated in FIG. 4 that was suggested by the geofence engine 214 (illustrated in FIG. 2) and the phase one gate 116 have been activated by the human PSAP operator. In an illustrative example, the PSAP human operator can click, select, or otherwise toggle the activate geofence indicator 414 to activate the geofence 102 and the phase one gate 116. In some examples, the geofence 102 is automatically activated by the geofence engine 214 and the phase one gate 116 is automatically activated by the phase one gate engine 216 and the human PSAP operator can click or select the activate geofence indicator 414 to deactivate the geofence 102. Note that if the geofence 102 is deactivated, the phase one gate 116 is automatically deactivated as there would not be a reason to delay communications to determine a precise location for the origin of the communication.

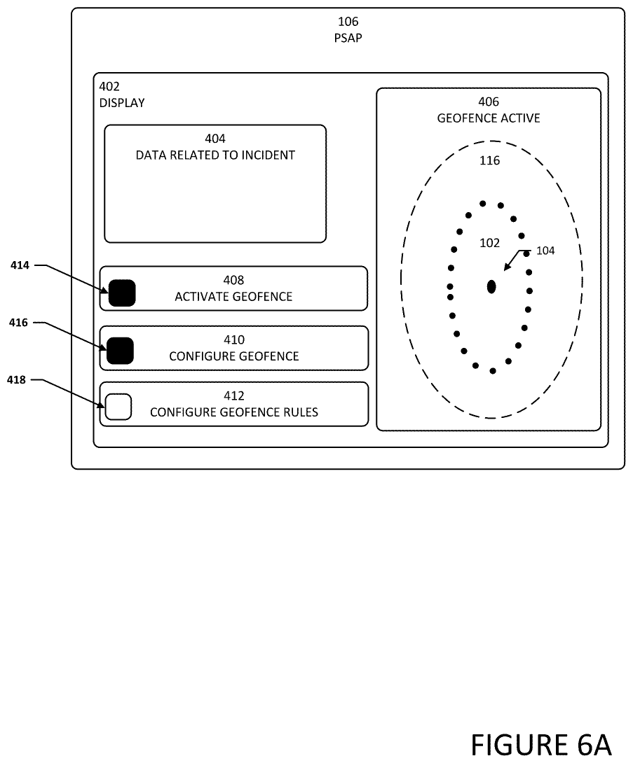

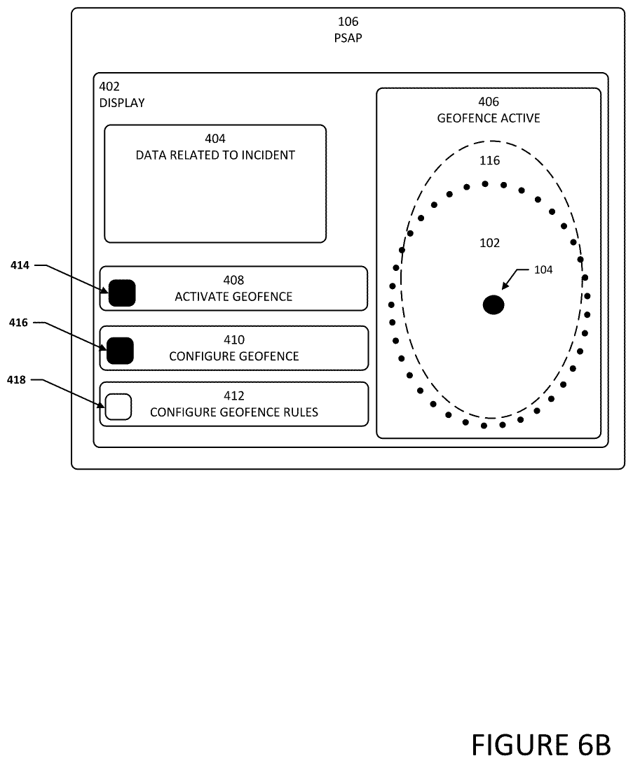

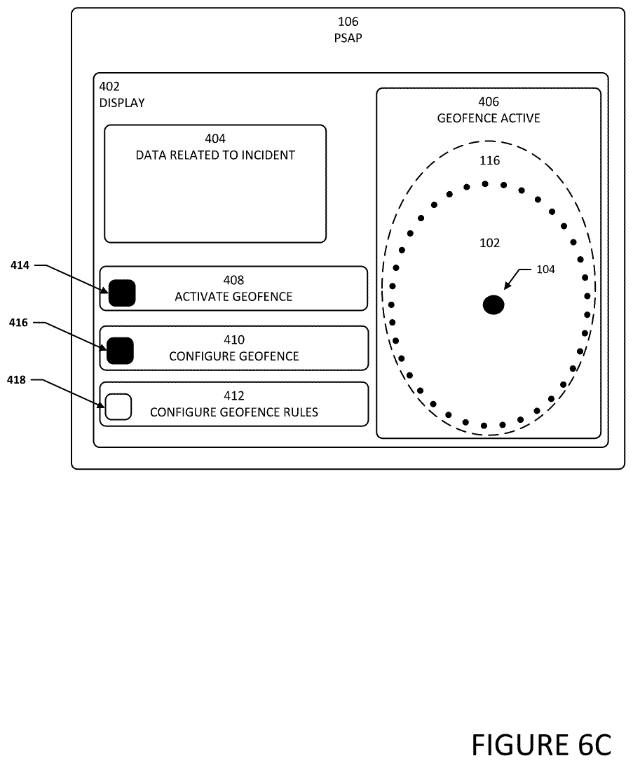

Turning to FIGS. 6A-6C, FIGS. 6A-6C are a simplified block diagrams illustrating specific non-limiting example details of the display 402 at the PSAP 106. As illustrated in FIGS. 6A-6C, the human operator at the PSAP can click, select, or otherwise activate the configure geofence selector 416 that allows the human PSAP operator to configure or change the shape, location, area covered, etc. of the geofence 102. For example, the geofence 102 illustrated in FIG. 6A has been changed when compared to the geofence 102 illustrated in FIG. 4 that was suggested by the geofence engine 214.

In some examples, when the geofence 102 is changed, the phase one gate 116 is also changed to include the area covered by the geofence 102. For example, as illustrated in FIG. 6B, the PSAP operator changed the geofence 102 such that the area of the geofence 102 extends outside the area of the phase one gate 116. When that occurs, the phase one gate 116 is automatically reconfigured to include the area of the geofence 102, as illustrated in FIG. 6C. In some examples, if cell tower information is used to create the boundaries of the phase one gate 116, the reconfiguring of the phase one gate 116 can including adding a cell tower to increase the area covered by the phase one gate 116.

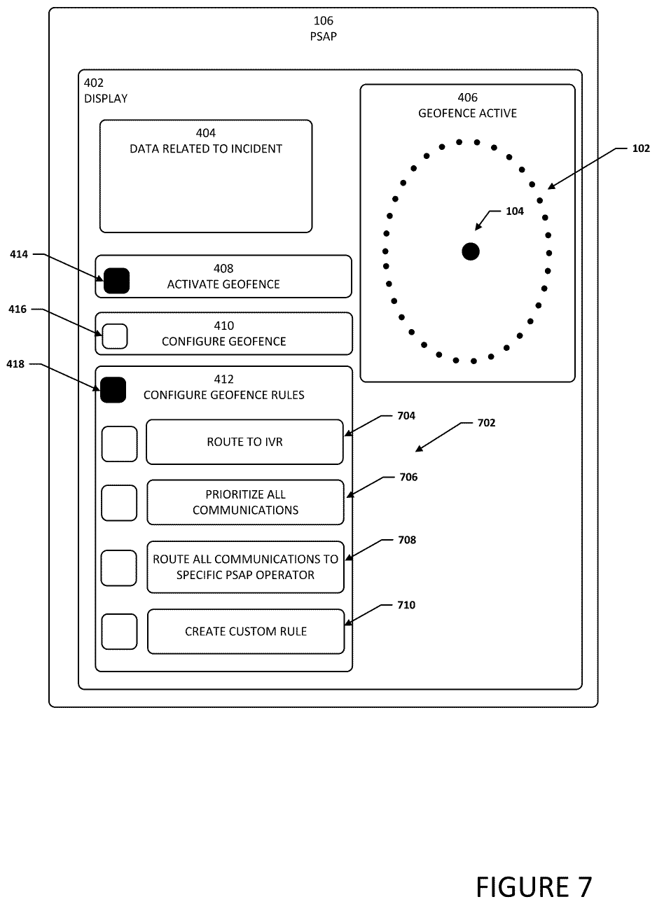

Turning to FIG. 7, FIG. 7 is a simplified block diagram illustrating specific non-limiting example details of the display 402 at the PSAP 106. As illustrated in FIG. 7, the human operator at the PSAP can click, select, or otherwise active the configure geofence rules selector 418 that allows the human PSAP operator to configure and associate one or more rules for the geofence 102. For example, as illustrated in FIG. 7, when the user selects the configure geofence rules selector 418, a drop-down menu 702 can appear with pre-configured rules that can be applied to the geofence 102. In some examples, a route all communications to an IVR rule 704 can be applied to all communications received by the PSAP 106 that originated inside the geofence 102. In other examples, a prioritize all communications rule 706 can be applied to all communications received by the PSAP 106 that originated inside the geofence 102. In yet other examples, a route all communications to a specific PSAP operator rule 708 can be applied to all communications received by the PSAP 106 that originated inside the geofence 102. If a PSAP operator does not see a pre-configured rule they want or if none of the pre-configured rules are applicable to the emergency event 104, the PSAP operator can select a create custom rule option 710 and create a custom rule specifically for the emergency event 104. In some examples, the created custom rule can be saved as a pre-configured rule and added to the drop-down menu 702 so a PSAP operator can quickly and easily associate the rule with the geofence 102.

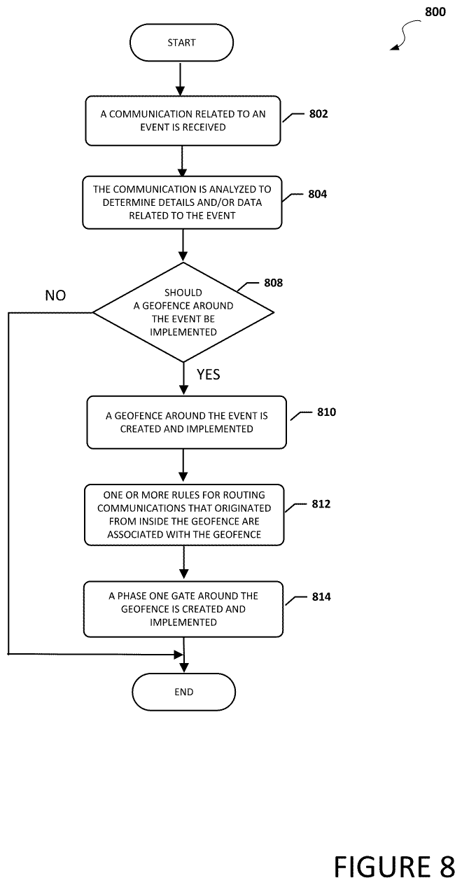

Turning to FIG. 8, FIG. 8 is example flowchart illustrating possible operations of a flow 800 that may be associated with potential operations to help enable geofencing around an event, in accordance with an embodiment of the present disclosure. Specifically, in some examples, one or more operations of flow 800 may be performed by the communication engine 108, the message receiving engine 204, the voice to text engine 206, the translation engine 208, the communication analysis engine 210, the location engine 212, the geofence engine 214, the phase one gate engine 216, and/or the communication routing engine 218. At 802, a communication related to an event is received. For example, a communication about the emergency event 104 can be received by the PSAP 106. At 804, the communication is analyzed to determine details and/or data related to the event. For example, the communication analysis engine 210 can determine the type of the event, the number of communications previously received about the event, details related to the event, etc.

At 808, the system determines if a geofence around the event should be implemented. For example, using the data related to the event and/or the details determine by the communication analysis engine 210, the geofence engine 214 can determine if a geofence should be implemented around the event. For example, if several communications are received regarding the same event, the geofence engine 214 can determine that a geofence should be implemented around the event. In another example, if the event is a car crash, fire, earthquake, active shooter or some other incident or event where a large volume of calls are expected, the geofence engine 214 can determine that a geofence should be implemented around the event. Also, if the event is one where a specialized or knowledgeable response is needed, the geofence engine 214 can determine that a geofence should be implemented around the event so communications inside the geofence can be routed to a PSAP operator to provide a specialized or knowledgeable response to the communications inside the geofence.

If the system determines a geofence around the event should not be implemented, the process ends. If the system determines a geofence around the event should be implemented, a geofence around the event is created and implemented, as in 810. For example, the geofence engine 214 can determine that a geofence should be established in the area around the event and automatically, without direct human intervention, create and implement the geofence around the event. In another example, a human operator at the PSAP can determine that a geofence should be established in the area around the event and the human operator can use the geofence engine 214 to create and implement the geofence 102 around the event. In yet other examples, the geofence engine 214 can suggest that a geofence should be established in the area around the event and a human operator at the PSAP can activate the geofence 102. In some examples, the human operator at the PSAP can alter or change the area the geofence 102 covers.

At 812, one or more rules for routing communications that originated from inside the geofence are associated with the geofence. For examples, using pre-configured rules from the rules database 220 and/or custom created rules, one or more rules can be associated with the geofence. More specifically, a rule can be applied that all communications inside the geofence are to be routed to a message about the emergency event. In another example, where as much information about the emergency event is needed (e.g., an active shooter) a rule can be applied that all communications inside the geofence are given top priority and are to be routed to PSAP operators specifically handling the response to the emergency event. In yet another example, a rule can be applied that all communications are to be routed to a specific PSAP operator who is handling the response to the emergency event. At 814, a phase one gate around the geofence is created and implemented. For example, the phase one gate engine 216 can create a phase one gate 116 around the geofence 102.

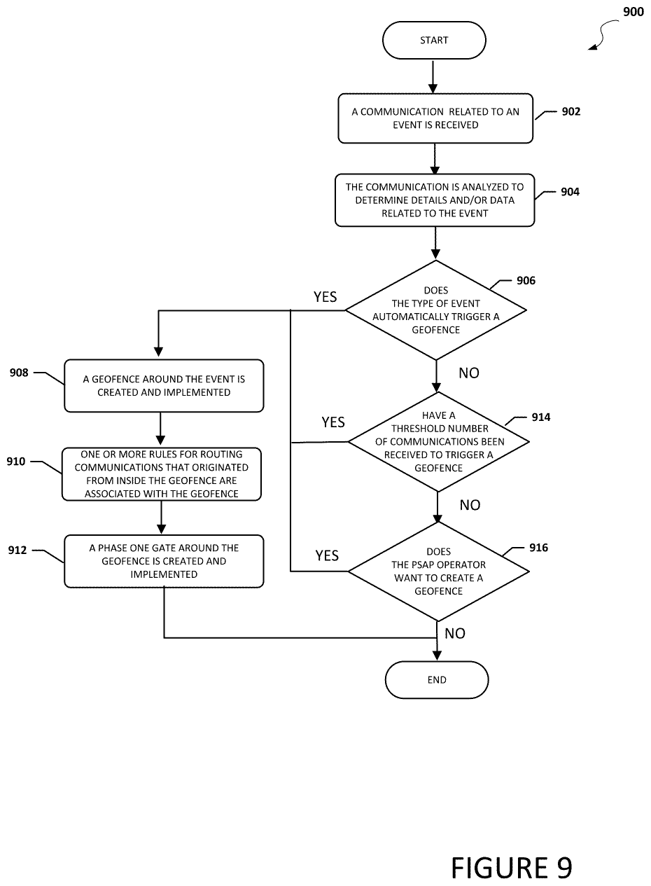

Turning to FIG. 9, FIG. 9 is example flowchart illustrating possible operations of a flow 900 that may be associated with potential operations to help enable geofencing around an event, in accordance with an embodiment of the present disclosure. Specifically, in some examples, one or more operations of flow 900 may be performed by the communication engine 108, the message receiving engine 204, the voice to text engine 206, the translation engine 208, the communication analysis engine 210, the location engine 212, the geofence engine 214, the phase one gate engine 216, and/or the communication routing engine 218. At 902, a communication related to an event is received. For example, a communication about the emergency event 104 can be received by the PSAP 106. At 904, the communication is analyzed to determine details and/or data related to the event. For example, the communication analysis engine 210 can determine the type of the event, the number of communications previously received about the event, details related to the event, etc.

At 906, the system determines if the type of event automatically triggers a geofence. For example, the geofence engine 214 can determine that a geofence should be established in the area around the event and automatically, without direct human intervention, create and implement the geofence around the event. More specifically, if the event is a car crash, fire, earthquake, active shooter or some other incident or event where a large volume of calls are expected, the geofence engine 214 can determine that a geofence should be implemented around the event and automatically, without direct human intervention, create and implement the geofence around the event.

If the type of event automatically triggers a geofence, a geofence around the event is created and implemented, as in 908. For example, based on the type of event, the geofence engine 214 can determine that a geofence should be established in the area around the event and automatically, without direct human intervention, create and implement the geofence around the event. In another example, based on the type of event, the geofence engine 214 can suggest that a geofence should be established in the area around the event and a human operator at the PSAP can activate the geofence. In some examples, the human operator at the PSAP can alter or change the area the geofence covers.

At 910, one or more rules for routing communications that originated from inside the geofence are associated with the geofence. For examples, using pre-configured rules from the rules database 220 and/or custom created rules, one or more rules can be associated with the geofence. More specifically, a rule can be applied that all communications inside the geofence are to be routed to a message about the emergency event. In another example, where as much information about the emergency event is needed (e.g., an active shooter) a rule can be applied that all communications inside the geofence are given top priority and are to be routed to PSAP operators specifically handling the response to the emergency event. In yet another example, a rule can be applied that all communications are to be routed to a specific PSAP operator who is handling the response to the emergency event. At 912, a phase one gate around the geofence is created and implemented. For example, the phase one gate engine 216 can create a phase one gate 116 around the geofence 102.

Going back to 906, if the type of event does not automatically trigger the geofence, the system determines if a threshold number of communications have been received to trigger the geofence, as in 914. The threshold number of communications can depend on the type of event, the time of day, the area where the event occurred, historical data related to the event, the call volume of the PSAP, and other factors. For example, if the event is a wild animal sighting, the event of a wild animal sighting would not be a type of event that would automatically trigger a geofence. However, the wild animal might be in a populated area and multiple people may be communicating with the PSAP to report the wild animal sighting. Receiving multiple communications about a wild animal sighting, where each communication is similar, can tie up PSAP resources. When a threshold number of communications have been received about the same event, the geofence can be triggered. The threshold number can be five or more communications, ten or more communications, fifty or more communications, or some other threshold number. In some examples, the PSAP operator can set the threshold number for each event. In other examples, the threshold number is a set number of communications independent of the type of event. If the threshold number of communications has been received to trigger a geofence, a geofence around the event is created and implemented, as in 908.

If the threshold number of communications has not been received to trigger a geofence, the system determines if the PSAP operator wants to create a geofence, as in 916. For example, a PSAP operator may create a geofence even though the threshold number of communications has not been received to trigger a geofence. In another example, the event may not be a type of event that automatically triggers a geofence, however, the PSAP operator may determine that a geofence needs to be created in anticipation of multiple communications related to the event. If the PSAP operator wants to create a geofence, a geofence around the event is created and implemented, as in 908.

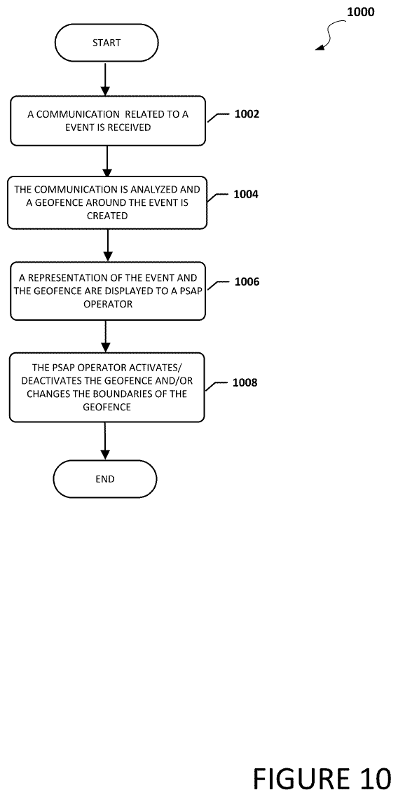

Turning to FIG. 10, FIG. 10 is example flowchart illustrating possible operations of a flow 1000 that may be associated with potential operations to help enable geofencing around an event, in accordance with an embodiment of the present disclosure. Specifically, in some examples, one or more operations of flow 1000 may be performed by the communication engine 108, the message receiving engine 204, the voice to text engine 206, the translation engine 208, the communication analysis engine 210, the location engine 212, the geofence engine 214, the phase one gate engine 216, and/or the communication routing engine 218. At 1002, a communication related to an event is received. For example, a communication about the emergency event 104 can be received by the PSAP 106. At 1004, the communication is analyzed and a geofence around the event is created. For example, the communication analysis engine 210 can determine details and/or data related to the event and the geofence engine 214 can use the determined details and/or data to create and implemented a geofence around the event. At 1006, a representation of the event and the geofence are displayed to a PSAP operator. At 1008, the PSAP operator activates/deactivates the geofence and/or changes the boundaries of the geofence.

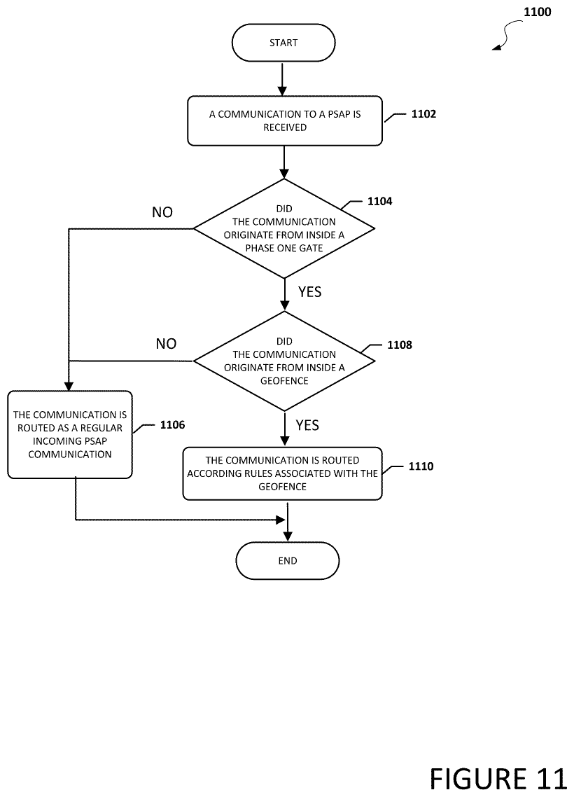

Turning to FIG. 11, FIG. 11 is example flowchart illustrating possible operations of a flow 1100 that may be associated with potential operations to help enable geofencing around an event, in accordance with an embodiment of the present disclosure. Specifically, in some examples, one or more operations of flow 1100 may be performed by the communication engine 108, the message receiving engine 204, the voice to text engine 206, the translation engine 208, the communication analysis engine 210, the location engine 212, the geofence engine 214, the phase one gate engine 216, and/or the communication routing engine 218. At 1102, a communication to a PSAP is received. At 1104, the system determines if the communication originated from inside a phase one gate. For example, the communication analysis engine 210 can use cell tower data to determine a general location of the area from where the communication originated and if the communication originated from inside a phase one gate. If the communication did not originate from inside a phase one gate, the communication is routed as a regular incoming PSAP communication, as in 1106. If the communication did originate inside a phase one gate, the system determines if the communication originated from inside a geofence, as in 1108. For example, the communication analysis engine 210 can determine the precise location of the origination of the communication and determine if the communication originated from inside a geofence. If the communication did not originate from inside a geofence, the communication is routed as a regular incoming PSAP communication, as in 1106. If the communication did originate from inside a geofence, the communication is routed according to the rules associated with the geofence that includes the location of where the communication originated, as in 1110.

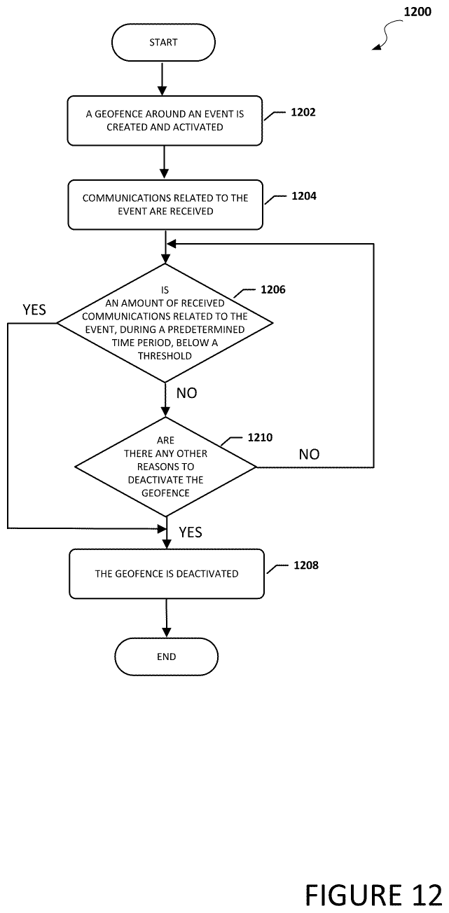

Turning to FIG. 12, FIG. 12 is example flowchart illustrating possible operations of a flow 1200 that may be associated with potential operations to help enable geofencing around an event, in accordance with an embodiment of the present disclosure. Specifically, in some examples, one or more operations of flow 1200 may be performed by the communication engine 108, the message receiving engine 204, the voice to text engine 206, the translation engine 208, the communication analysis engine 210, the location engine 212, the geofence engine 214, the phase one gate engine 216, and/or the communication routing engine 218. At 1202, a geofence around an event is created and activated or implemented. For example, the geofence engine 214 can determine that a geofence should be established in the area around an event and automatically, without direct human intervention, create and implement the geofence around the event. In another example, a human operator at the PSAP can determine that a geofence should be established in the area around the event and the human operator can use the geofence engine 214 to create and implement the geofence 102 around the event. In yet other examples, the geofence engine 214 can suggest that a geofence should be established in the area around the event and a human operator at the PSAP can activate the geofence 102. In some examples, the human operator at the PSAP can alter or change the area the geofence 102 covers. In addition, in some examples, one or more rules for routing communications that originated from inside the geofence are associated with the geofence.

At 1204, communications related to the event are received. For example, communications related the event can be received by the message receiving engine 204. At 1206, the system determines if, during a predetermined time period, an amount of received communications related to the event is below a threshold. For example, the communication engine 108 can be configured to determine an amount of, or how many, communications related to the event were received during a predetermined time period (e.g., 1 minute, 2.5 minutes, 5 minutes, 10 minutes, 30 minutes, etc.). More specifically, in a specific non-limiting example, the communication engine 108 can be configured to determine the amount communications related to the event were received in the last five (5) minutes.

If, during the predetermined time period, the amount of received communications related to the event is below a threshold, the geofence is deactivated, as in 1208. For example, if zero (0) communications related to the event were received in the last five (5) minutes, then the geofence is no longer needed and can be deactivated. If the amount of received communications related to the event, during the predetermined time period, is not below a threshold, the system determines if there are any other reasons to deactivate the geofence, as in 1210. For example, the nature of the event may have changed such that a geofence is not longer needed or necessary. If there is any other reason to deactivate the geofence, then the geofence is deactivated, as in 1208. If there are not any other reasons to deactivate the geofence, then the system returns to 1206 where the system determines if, during a predetermined time period, an amount of received communications related to the events below a threshold. The threshold amount may be one (1) communication, two (2) communications, three (3) communications, or some other amount or number of communications that can indicate the geofence should be deactivated.

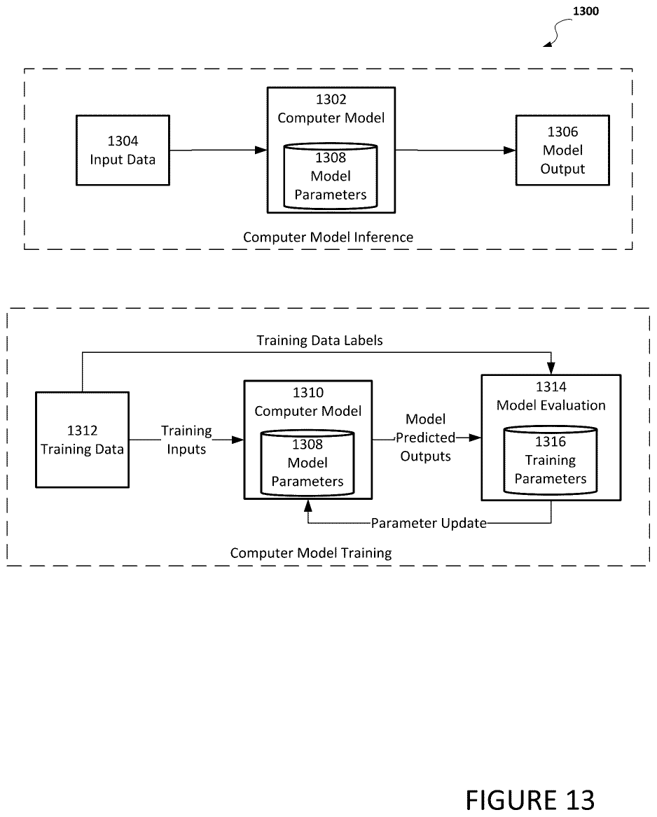

Turning to FIG. 13, FIG. 13 illustrates example computer model inference and computer model training 1300. Computer model inference refers to the application of a computer model 1302 to a set of input data 1304 to generate an output or model output 1306. The computer model 1302 determines the model output 1306 based on parameters of the model, also referred to as model parameters 1308. The parameters of the model may be determined based on a training process that finds an optimization of the model parameters 1308, typically using training data and desired outputs of the model for the respective training data as discussed below. The output (e.g., creating a geofence around an event) of the computer model 1302 may be referred to as an “inference” because it is a predictive value based on the input data 1304 and based on previous example data used in the model training.

The input data 1304 and the model output 1306 vary according to the particular use case. For example, to determine when to establish a geofence, the input data 1304 may be a text or audio communication related to an event and the output or “inference” may be a suggested geofence around the event. To determine the size and shape of the geofence, the input data 1304 may be previously created and implemented geofences around similar events and the output or “inference” may be a suggested size and shape of the geofence.

In an illustrative example of computer vision and image analysis, the input data 1304 may be an image having a particular resolution, such as 75×75 pixels, or a point cloud describing a volume. In other applications, the input data 1304 may include a vector, such as a sparse vector, representing information about an object. For example, in recommendation systems, such a vector may represent user-object interactions, such that the sparse vector indicates individual items positively rated by a user. In addition, the input data 1304 may be a processed version of another type of input object, for example representing various features of the input object or representing preprocessing of the input object before input of the object to the computer model 1302. As one example, a 1024×1024 resolution image may be processed and subdivided into individual image portions of 64×64, which are the input data 1304 processed by the computer model 1302. As another example, the input object, such as a sparse vector discussed above, may be processed to determine an embedding or another compact representation of the input object that may be used to represent the object as the input data 1304 in the computer model 1302. Such additional processing for input objects may themselves be learned representations of data, such that another computer model processes the input objects to generate an output that is used as the input data 1304 for the computer model 1302. Although not further discussed here, such further computer models may be independently or jointly trained with the computer model 1302. As noted above, the model output 1306 may depend on the particular application of the computer model 1302, for example, creating a geofence around an event.

The computer model 1302 includes various model parameters 1308, as noted above, that describe the characteristics and functions that generate the model output 1306 from the input data 1304. In particular, the model parameters 1308 may include a model structure, model weights, and a model execution environment. The model structure may include, for example, the particular type of computer model 1302 and its structure and organization. For example, the model structure may designate a neural network, which may be comprised of multiple layers, and the model parameters 1308 may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 1302 processes the input data 1304 to the model output 1306. Each portion or layer of the computer model 1302 may have such weights. For example, weights may be used to determine values for processing inputs to determine outputs at a particular portion of a model. Stated another way, for example, model weights may describe how to combine or manipulate values of the input data 1304 or thresholds for determining activations as output for a model. As one example, a convolutional layer typically includes a set of convolutional “weights,” also termed a convolutional kernel, to be applied to a set of inputs to that layer. These are subsequently combined, typically along with a “bias” parameter, and weights for other transformations to generate an output for the convolutional layer.

The model execution parameters represent parameters describing the execution conditions for the model. In particular, aspects of the model may be implemented on various types of hardware or circuitry for executing the computer model 1302. For example, portions of the model may be implemented in various types of circuitry, such as general-purpose circuity (e.g., a general CPU), circuity specialized for certain functions (e.g., a GPU or programmable Multiply-and-Accumulate circuit) or circuitry specially designed for the particular computer model application. In some configurations, different portions of the computer model 1302 may be implemented on different types of circuitries. As discussed below, training of the model may include optimizing the types of hardware used for certain aspects of the computer model 1302 (e.g., co-trained), or may be determined after other parameters for the computer model 1302 are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters 1308 for the computer model 1310. During training, the model parameters 1308 are optimized to “learn” values of the model parameters (such as individual weights, activation values, model execution environment, etc.), that improve the model parameters 1308 based on an optimization function that seeks to improve a cost function (also sometimes termed a loss function). Before training, the computer model 1310 has model parameters 1308 that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 1312 includes a data set to be used for training the computer model 1310. The data set varies according to the particular application and purpose of the computer model 1310. In supervised learning tasks, the training data 1312 typically includes a set of training data labels that describe the training data 1312 and the desired output of the model relative to the training data 1312. For example, for an object classification task, the training data 1312 may include individual images in which individual portions, regions or pixels in the image are labeled with the classification of the object. For this task, the training data 1312 may include a training data image depicting a dog and a person and training data labels that label the regions of the image that include the dog and the person, such that the computer model 1310 is intended to learn to also label the same portions of that image as a dog and a person, respectively. In another example, the training data 1312 may include various communications to a PSAP labeled with the creation of a geofence such that the computer model 1310 is intended to learn to create a geofence based on similar communications.

To train the computer model 1310, a training module (not shown) applies the training inputs to the computer model 1310 to determine the outputs predicted by the model for the given training inputs. The training module, though not shown, is a computing module used for performing the training of the computer model 1310 by executing the computer model 1310 according to its inputs and outputs given the model's parameters and modifying the model parameters based on the results. The training module may apply the actual execution environment of the computer model 1310, or may simulate the results of the execution environment, for example to estimate the performance, runtime, memory, or circuit area (e.g., if specialized hardware is used) of the computer model 1310. The training module, along with the training data 1312 and model evaluation, may be instantiated in software and/or hardware by one or more processing devices. In various examples, the training process may also be performed by multiple computing systems in conjunction with one another, such as distributed/cloud computing systems. In some examples the training of the computer module 1310 may be different if the computer model 1310 is a large language model (LLM) used for automated message responses as compared to being used to the creation of a geofence. A LLM is used for language-based tasks, whereas the general AI model can be used for a variety of other tasks, including creating a geofence and a phase one gate around an event.

After processing the training inputs according to the current model parameters for the computer model 1310, the model's predicted outputs are evaluated and the computer model 1310 is evaluated with respect to the cost function and optimized using an optimization function of the training model. Depending on the optimization function, particular training process and training parameters 1316 after the model evaluation are updated to improve the optimization function of the computer model 1310. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model 1310 and may be measured in various ways, such as the precision (frequency of false positives) and recall (frequency of false negatives). The cost function in some circumstances may also evaluate other characteristics of the model, for example the model complexity, processing speed, memory requirements, physical circuit characteristics (e.g., power requirements, circuit throughput) and other characteristics of the computer model 1310 structure and execution environment (e.g., to evaluate or modify these model parameters).

After determining results of the cost function, the optimization function determines a modification of the model parameters to improve the cost function for the training data 1312. Many such optimization functions are known to one skilled on the art. Many such approaches differentiate the cost function with respect to the parameters of the model and determine modifications to the model parameters that thus improves the cost function. The parameters for the optimization function, including algorithms for modifying the model parameters are the training parameters 1316 for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data 1312 is batched and the parameter updates are iteratively applied to batches of the training data 1312. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data 1312 available or the incremental improvements in model parameters are below a threshold (e.g., additional training data 1312 no longer continues to improve the model parameters). Additional training parameters 1316 may describe the batch size for the training data 1312, a portion of training data 1312 to use as validation data, the step size of parameter updates, a learning rate of the model, and so forth. Additional techniques may also be used to determine global optimums or address nondifferentiable model parameter spaces.

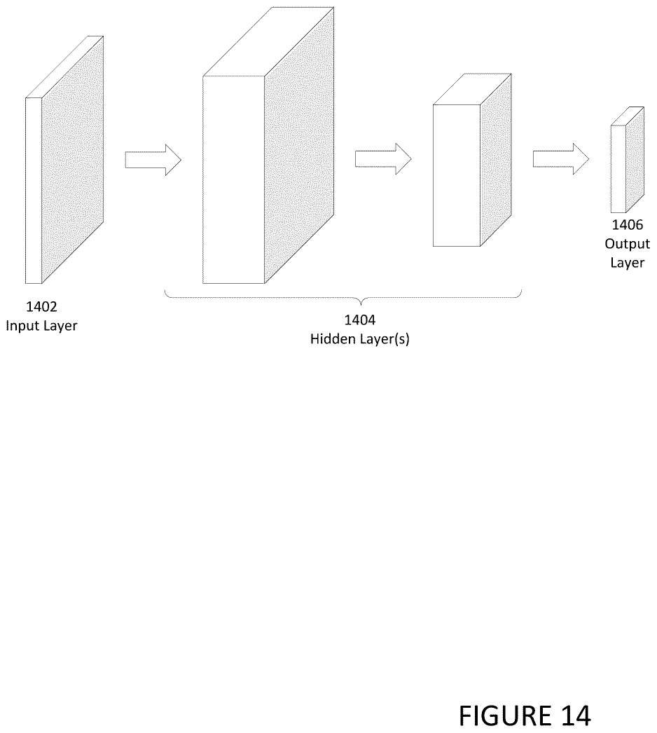

Turning to FIG. 14, FIG. 14 illustrates an example neural network architecture. In general, a neural network includes an input layer 1402, one or more hidden layers 1404, and an output layer 1406. The values for data in each layer of the network is generally determined based on one or more prior layers of the network. Each layer of a network generates a set of values, termed “activations” that represent the output values of that layer of a network and may be the input to the next layer of the network. For the input layer 1402, the activations are typically the values of the input data, although the input layer 1402 may represent input data as modified through one or more transformations to generate representations of the input data. For example, in recommendation systems, interactions between users and objects may be represented as a sparse matrix. Individual users or objects may then be represented as an input layer 1402 as a transformation of the data in the sparse matrix relevant to that user or object. The neural network may also receive the output of another computer model (or several), as its input layer 1402, such that the input layer 1402 of the neural network shown in FIG. 14 is the output of another computer model. Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network, except for the final output layer of 1406 of the network.

Each layer of the neural network typically represents its output activations (i.e., also termed its outputs) in a matrix, which may be 1, 2, 3, or n-dimensional according to the particular structure of the network. As shown in FIG. 14, the dimensionality of each layer may differ according to the design of each layer. The dimensionality of the output layer 1406 depends on the characteristics of the prediction made by the model. For example, a computer model for multi-object classification may generate an output layer 1406 having a one-dimensional array in which each position in the array represents the likelihood of a different classification for the input layer 1402. In another example for classification of portions of an image, the input layer 1402 may be an image having a resolution, such as 512×512, and the output layer may be a 512×512×n matrix in which the output layer 1406 provides n classification predictions for each of the input pixels, such that the corresponding position of each pixel in the input layer 1402 in the output layer 1406 is an n-dimensional array corresponding to the classification predictions for that pixel.

The hidden layers 1404 provide output activations that variously characterize the input layer 1402 in various ways that assist in effectively generating the output layer 1406. The hidden layers thus may be considered to provide additional features or characteristics of the input layer 1402. Though two hidden layers are shown in FIG. 14, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 1406. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 1402 is reached.

In the description, various aspects of the illustrative implementations are described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. The terms “substantially,” “close,” “approximately,” “near,” and “about,” generally refer to being within +/−20% of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Substantial flexibility is provided by the system, apparatus, and method to enable geofencing around an event in that any suitable arrangements, chronologies, configurations, and timing mechanisms may be provided without departing from the teachings of the present disclosure.

Note that embodiments of the communication engine 108, the message receiving engine 204, the voice to text engine 206, the translation engine 208, the communication analysis engine 210, the location engine 212, the geofence engine 214, the phase one gate engine 216, and the communication routing engine 218 may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces, may include physical ports (e.g., Ethernet, USB, HDMI, etc.), interfaces for wired and wireless internal subsystems, and the like. Similarly, the communication engine 108, the message receiving engine 204, the voice to text engine 206, the translation engine 208, the communication analysis engine 210, the location engine 212, the geofence engine 214, the phase one gate engine 216, and the communication routing engine 218 of the system can also include suitable interfaces for receiving, transmitting, and/or otherwise communicating data or information in a network environment.

The communication engine 108, the message receiving engine 204, the voice to text engine 206, the translation engine 208, the communication analysis engine 210, the location engine 212, the geofence engine 214, the phase one gate engine 216, and the communication routing engine 218 and other associated or integrated components can include one or more memory elements for storing information to be used in achieving operations associated with geofencing around an event, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the communication engine 108, the message receiving engine 204, the voice to text engine 206, the translation engine 208, the communication analysis engine 210, the location engine 212, the geofence engine 214, the phase one gate engine 216, and the communication routing engine 218 could be provided in any database, register, table, cache, queue, control list, or storage structure, based on particular needs and implementations, all of which could be referenced in any suitable timeframe. Any of the memory or storage options discussed herein should be construed as being encompassed within the broad term ‘memory element’ as used herein in this Specification.

In example embodiments, the operations for enabling geofencing around an event, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to carry out the geofencing around an event described in this Specification. Regarding a physical implementation of the communication engine 108, the message receiving engine 204, the voice to text engine 206, the translation engine 208, the communication analysis engine 210, the location engine 212, the geofence engine 214, the phase one gate engine 216, and the communication routing engine 218 and their associated components, any suitable permutation may be applied based on particular needs and requirements.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the system, apparatus, and method to enable geofencing around an event and their teachings are readily scalable and can accommodate a large number of components, as well as more complicated/sophisticated arrangements and configurations. Accordingly, the examples provided should not limit the scope or inhibit the broad teachings of the system, apparatus, and method to enable geofencing around an event and as potentially applied to a myriad of other architectures.

It is also important to note that the operations in the preceding flow diagrams (i.e., FIGS. 8-12) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
creating a geofence around an event;
creating a phase one gate around the geofence;
receiving a communication at a public safety answering point (PSAP); and
conditioned upon general location data, included in the communication received at the PSAP, indicating that the communication originated inside the phase one gate, delaying the communication until precise location data for the communication determines if the communication originated inside the geofence or outside of the geofence.

2. The method of claim 1, wherein the general location data included in the communication received at the PSAP that indicates the communication originated inside the phase one gate is cell tower information.

3. The method of claim 1, wherein the geofence was created by a computer model.

4. The method of claim 1, wherein one or more rules for routing communications that originated inside the geofence are associated with the geofence.

5. The method of claim 1, wherein a PSAP operator can change boundaries of the geofence.

6. The method of claim 5, wherein boundaries of the phase one gate change in response to the boundaries of the geofence being changed.

7. The method of claim 1, wherein a PSAP operator can activate and deactivate the geofence.

8. A system, comprising:
memory;
at least one processor;
a communication engine configured to:
analyze communications to a public safety answering point (PSAP);
determine, based on the analyzed communications to the PSAP, that a geofence should be implemented around an event;
create a geofence around the event; and
create a phase one gate around the geofence.

9. The system of claim 8, wherein a type of the event triggered the creation of the geofence.

10. The system of claim 8, wherein a volume of calls related to the event triggered the creation of the geofence.

11. The system of claim 8, wherein a computer model was used to determine that a geofence should be implemented around an event.

12. The system of claim 8, wherein one or more rules for routing communications that originated inside the geofence are associated with the geofence.

13. The system of claim 12, wherein a PSAP operator changes an area the geofence covers.

14. The system of claim 13, wherein, based on the change of the area the geofence covers, the phase one gate also changes an area the phase one gate covers.

15. A method, comprising:
automatically creating a geofence based on one or more communications to a public safety answering point (PSAP), wherein the one or more communications are related to an event; and
automatically creating a phase one gate around the geofence, wherein communications that originate inside the phase one gate are delayed to determine precise location information for the communications.

16. The method of claim 15, wherein the geofence and phase one gate are created using a computer model.

17. The method of claim 15, wherein the geofence is automatically created based on a type of the event.

18. The method of claim 15, wherein the geofence is created based on receiving a threshold number of other communications related to the event.

19. The method of claim 15, wherein one or more rules for routing communications that originated inside the geofence are associated with the geofence.

20. The method of claim 15, wherein a PSAP operator can change an area the geofence covers.
